(19) United States
(12) Patent Application Publication
(10) Pub. No.: US 2013/0151899 A1
(43) Pub. Date: Jun. 13, 2013

(54) DEBUG SYSTEM AND METHOD

(71) Applicant: KANG-BIN WANG, Shenzhen City (CN)

(72) Inventor: KANG-BIN WANG, Shenzhen City (CN)

(73) Assignees: HON HAI PRECISION INDUSTRY CO., LTD., Tu-Cheng (TW); HONG FU JIN PRECISION INDUSTRY (ShenZhen) Co., LTD, Shenzhen City (CN)

(21) Appl. No.: 13/562,766

(22) Filed: Jul. 31, 2012

(30) Foreign Application Priority Data
Dec. 12, 2011 (CN) 201110411720.3

(51) Int. Cl. G06F 11/34

(52) U.S. Cl. 714/27; 714/E11.189

(57) ABSTRACT

A debug system includes a debug device and a computer. The debug device includes a decoding module, a first storing module, a first control module; and a signal receiving and transmitting module. The computer includes a second control module, a second storing module, and a display module. The decoding module decodes data from the LPC bus. The first storing module stores decoded data. The second control module sends a set address data to the first control module via the signal receiving and transmitting module. The first control module obtains a corresponding data from the first storing module according to the set address data and send the corresponding data to the second control module via the signal receiving and transmitting module. The second control module stores the corresponding data to the second storing module and displays the corresponding data on the display module.

### BACKGROUND

1. Technical Field

The present disclosure relates to debug systems and methods, and more particularly to a debug system and a method based on a low ping count (LPC) bus.

2. Description of Related Art

FIG. 3, illustrates that in a computer system of the prior art, a north bridge module 30 is connected to south bridge module 50 via the direct memory interface (DMI) bus. The south bridge module 50 is connected to the basic input output system (BIOS) module 70 via the LPC bus. The traditional debug card is used for storing the data from the LPC bus and displays the data via the light-emitting diodes (LEDs). However, the LEDs are often limited in how much information they can convey, which may cause an operator performing the testing to be unclear regarding the debug information.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of one embodiment of a debug system.

FIG. 2 is a flowchart of one embodiment of a debug method.

FIG. 3 is a block diagram of a traditional computer system according to the prior art.

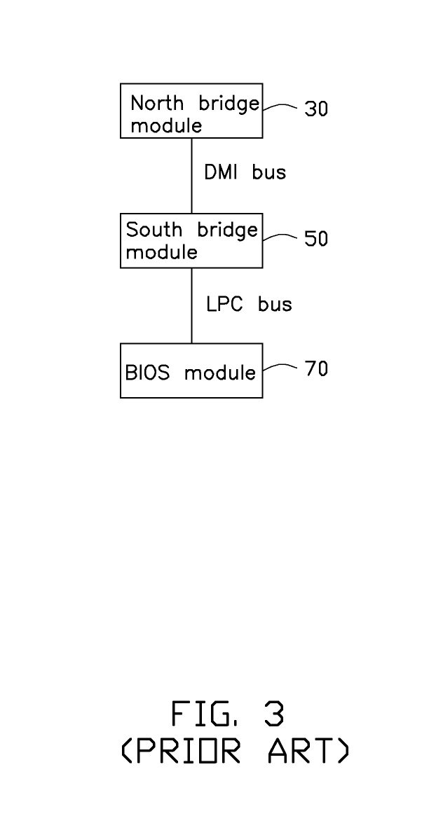

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or Assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

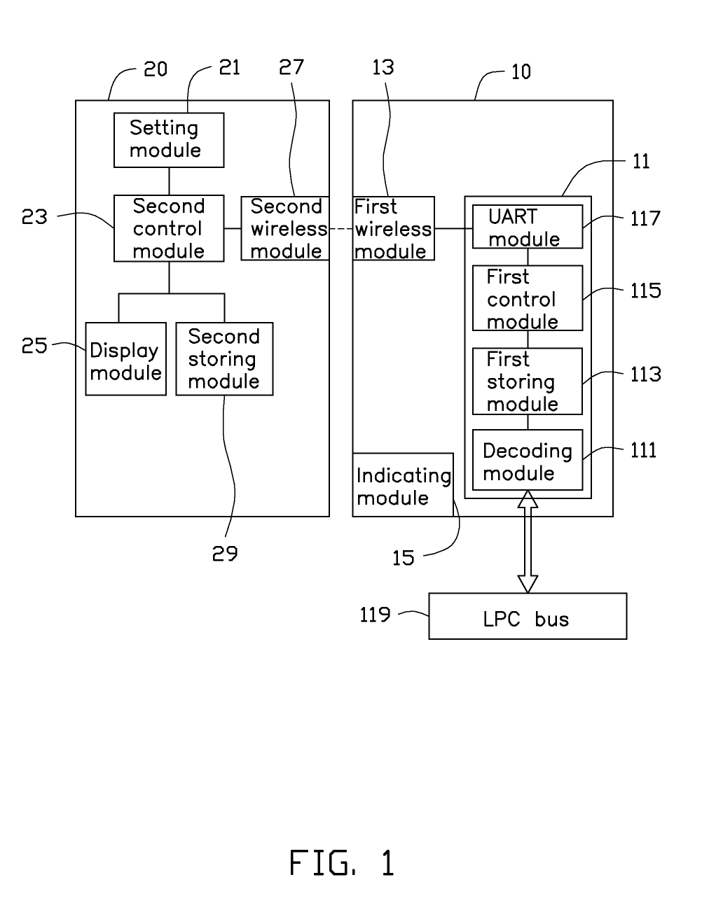

FIG. 1, illustrates a debug system according to one embodiment. The debug system includes a debug device 10 and a computer 20.

The debug device 10 includes a programmable logic device (PLD) 11, a first wireless module 13 connected to the PLD 11, and an indicator module 15 connected to the PLD 11. In one embodiment, the PLD 11 is a complex programmable logic device, the first wireless module 13 is a PRT200 IC chip. The indicator module 15 is a light-emitting diode (LED). The indicator module 15 is used for indicating the work status of the PLD 11.

The PLD 11 includes decoding module 111, a first storing module 113, a first control module 115, and a signal receiving and transmitting module. In one embodiment, the signal receiving and transmitting module is a universal asynchronous receiver and transmitter (UART) module 117. The first storing module 113 is a dual port random access memory (DPRAM). The decoding module 111 is connected to a LPC bus 119 of motherboard (not shown). The decoding module 111 is used for decoding the data from the LPC bus 119 and storing the decoded data to the first storing module 113 when the motherboard is trigged to be powered on.

The computer 20 includes a setting module 21, a second control module 23, a display module 25, a second wireless module 27, and a second storing module 29. In one embodiment, the second control module 23 is a central processing unit (CPU). The display module 25 is liquid crystal display (LCD). The second storing module 29 is a hard disk drive. There are wireless signals transmitted between the second wireless module 27 and the first wireless module 13. The user can set address data via the setting module 21, such as 80 H.

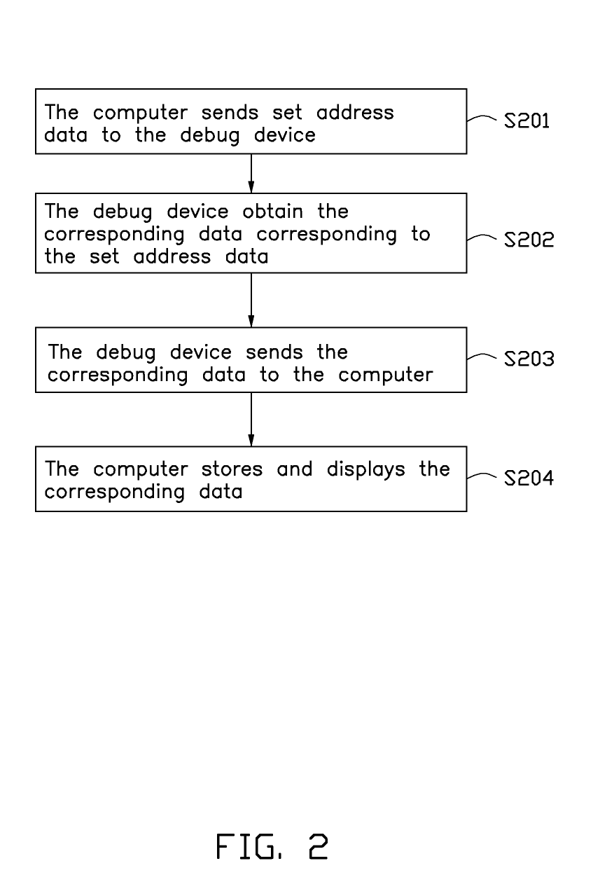

Referring to FIGS. 1 and 2, a debug method according to one embodiment is shown as following steps.

S201, the computer 20 sends set address data to the first wireless module 13 vi the second wireless module 27. The first wireless module 13 transmits the set address data to the first control module 115 via the UART module 117.

S202, the first control module 115 of the debug device 10 obtains corresponding codes corresponding to the set address data from the first storing module 113. In one embodiment, the decoding module 111 sends a finished signal to the first control module 115 after decoding the codes from the LPC bus 119. The first control module 115 obtains the codes corresponding to the set address data from the first storing module 113 after receiving the finished signal and the set address data.

S203, the first control module 115 of the debug device 10 sends the corresponding codes to the second wireless module 27 via the UART module 117 and the first wireless module 13. The second wireless module 27 transmits the corresponding data to the second control module 23 of the computer 20.

S204, the second control module 23 of the computer 20 stores the corresponding data to the second storing module 29 and then displays the corresponding data on the display module 25.

The decoding module 111 decodes the new codes from the LPC bus 119 and stores the new decodes codes to the first storing module 113, when the motherboard is trigged to be powered on again. The second control module 23 stores the new corresponding data to the second storing module 29. The second control module 23 displays all the data stored in the second storing module 29 on the display module 25.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A debug system, comprising:
a debug device, the debug device comprising:
a decoding module, the decoding module is connected to a LPC bus of a motherboard and is configured to decode data from the LPC bus;
a first storing module, the first storing module configured to store decoded data;
a first control module; and
a signal receiving and transmitting module; and
a computer, the computer comprising:
a second control module, the second control module configured to send set address data to the signal receiving and transmitting module;
a second storing module; and
a display module;
wherein the signal receiving and transmitting module is configured to send the set address data to the first control module; the first control module is configured to obtain corresponding data from the first storing module according to the set address data and send the corresponding data to the second control module via the signal receiving and transmitting module; and the second control module is further configured to store the corresponding data, to the second storing module, and display the corresponding data on the display module.

2. The debug system of claim 1, wherein the debug device further comprises a first wireless module connected to the signal receiving and transmitting module; the computer further comprises a second wireless module connected to the second control module; and the first wireless module are configured to send the corresponding data to the second control module via the second wireless module.

3. The debug system of claim 1, wherein the decoding module is configured to send a finished signal to the first control module after decoding the data from the LPC bus; and the first control module is further configured to obtain the corresponding data after receiving the finished signal and the set address data.

4. The debug system of claim 1, wherein the signal receiving and transmitting module is a UART module.

5. The debug system of claim 1, wherein the debug device further comprises a PLD; and the decoding module, the first storing module, the first control module, and the signal receiving and transmitting module are together formed in the PLD.

6. A debug method comprising:
decoding data from a LPC bus of a motherboard after the motherboard is trigged to be powered on, and storing decoded data via a debug device;
sending set address data via a computer to the debug device;
transmitting corresponding data corresponding to the set address data via the debug device to the computer; and
storing and displaying the corresponding data via the computer.

7. The debug method of claim 6, wherein the transmitting the corresponding data comprises transmitting the corresponding data via a wireless manner

8. The debug method of claim 6, wherein the decoding the data from the LPC bus comprises decoding the data via a PLD of the debug device.

9. The debug method of claim 8, further comprising indicating a work status of the PLC via an LED.
